(19) United States
(12) Patent Application Publication
(10) Pub. No.: US 2006/0232443 A1
(43) Pub. Date: Oct. 19, 2006

(54) Reflectors for delineating unlit runways

(76) Inventor: Gavin Richard Brown, Durban (ZA)

Correspondence Address: YOUNG & THOMPSON, 745 SOUTH 23RD STREET, 2ND FLOOR, ARLINGTON, VA, 22202, US

(21) Appl. No.: 11/369,948

(22) Filed: Mar. 8, 2006

Related U.S. Application Data
(63) Continuation of application No. PCT/ZA04/00064, filed on Jun. 8, 2004.

(30) Foreign Application Priority Data
Sep. 8, 2003 (ZA) 2003/6983

(51) Int. Cl. B64F 1/18

(52) U.S. Cl. 340/953; 359/530

(57) ABSTRACT

A reflector for use as an aircraft runway marker (10) has an arcuate surface (12) with reflective foil (14) applied thereto. The arcuate surface is mounted on a pole (16) with spacers (18) between the pole and the rear of the arcuate surface. The spacers decrease in width progressively up the pole forming the arcuate surface into a complex curve capable of reflecting light from an approaching aircraft to illuminate or demarcate a runway.

### TECHNICAL FIELD OF THE INVENTION

This invention relates to reflectors for delineating unlit runways.

### BACKGROUND ART

Aircraft flying into rural airfields face considerable difficulties in landing at night where the runway is unlit by artificial lighting.

Currently, the standard procedure involves ground personnel using the lights of three motor vehicles to assist the pilot. Two vehicles are parked with their headlights on and criss-crossing at a point identified as the touch down point, while a third vehicle is parked at the opposite end of the runway with its tail lights on, acting as a directional indicator.

Currently on take off, a motor vehicle is parked at the far end of the runway with its tail lights on. This vehicle is used as a centre line indicator. The aircraft moves and accelerates towards the motor vehicle and take off when sufficient flying speed is reached. When the runway, along its length, has a convex vertical curve along its length, the end of the runway cannot be seen. When this occurs, the line up vehicle has to move closer to the take off point to be visible to the craft. Fatal accidents or near misses between the vehicle and the aircraft have been recorded when the marker vehicle has moved too close to the aircraft taking off and the collision has occurred.

This is not an entirely satisfactory system, and accordingly it is an object of this invention to provide reflectors for use in night landing at unlit runways, which are visible for a variety of approach or glide angles, are relatively inexpensive to manufacture, easy to install and comply with aviation regulations. In addition, the reflectors may be visible for approach from two directions. The aircraft's landing lights provide the illumination for the reflector landing system.

This invention will also provide reflectors for use in taking off from unlit runways. The reflectors delineate the edge of the runway which enables the pilot to maintain directional control within the confines of the runway. A reflector is placed on centre line, 25 metres past the end of the runway, to indicate the end of the runway. The end of the runway is clearly depicted by the end of the edge of markers.

U.S. Pat. No. 5,175,645

This patent describes a descent path indicator comprising 3 planar surfaces which are retro-reflecting. The upper and lower planar surfaces intersect the central plane at 145°-150°.

Bennett's indicator is firstly substantially different from that described in this application as it employs planar surfaces as opposed to a single curved (arcuate) surface. The compound curvature permits visibility by light reflected from the retro-reflective surface, from angles of inclination ranging from zero to 25°.

The Bennett patent does not take into account the fact that the landing lights of the aircraft and the glide slope do not coincide. Accordingly, the Bennett patent gives an incorrect glide slope indicator as the incident of light has to strike the panel with aircraft at a steeper angle than the glide slope. The size of the reflector to distinguish between 3 surfaces means that the aircraft has to be extremely close as it is difficult to discern which sections are darker than the other, as the dominant brightest colour will suffice. This reflector is therefore a short range instrument.

The use of colours with white does not work as the white predominates except if extremely close proximity.

By having flat surfaces as opposed to an arcuate surface, the patent does not take into account the difference in the angles between the light source and the pilots eyes, which is noticeable when the glide slope and the angle of the aircraft lights diverge. When an aircraft comes in to land, flaps are lowered which increases drag and increases lift so that the aircraft can approach to land at a slower speed. With the aircraft approaching with partial or full flaps, the centre of pressure on the wing moves forward and to counteract this aspect, the pilot must pitch the nose down towards the undercarriage to balance the shift of the uplift component. Pitching the nose down deflects the landing light lower than the glide slope and therefore curvature of the reflector is required to get the best benefit of light reflectivity.

It is therefor important that the reflector surface is arcuate and this distinguishes the applicant's invention from U.S. Pat. No. 5,175,645 (D1).

US 2002/0017042

This patent describes an aircraft approach and landing system using passive retro-reflective panels located alongside a landing strip and comprises pairs of colour-coded orange panel markers to indicate the touchdown zone and the remainder of the landing strip.

This system tilts back the reflector to match a standard descent slope of an approaching aircraft, but as mentioned in the previous patent does not take into account that the glide slope and the position of the lights do not match. Also for this to be accurate each reflector would have to be tilted back separately for the best affect. It does not do that.

The philosophy of curving the reflectors towards the centre line of the runway is a design fault, as
(1) It reduces the forward visibility as the reflectivity at optimum reflection is moved closer to the touch down area.
(2) Having a set of reflectors curved towards the centre on the runway allows the aircraft to approach the threshold at wider angles, which in rural runways is dangerous due to obstructions that are always close to the sides of runways. Designs of runways try to form cones of safe approaches. By turning the reflectors inwards, opens up the cone beyond the safe requirements when approaching from the side. Reaction time of the pilot is also reduced. The whole runway cannot be seen because the landing lights do not shine on the whole runway.
(3) By having the reflectors concaved the way they are, the far end of the runway does not have good illumination for take offs, as the reflectors are pointing away from the runway.
   GB 013 079 (Berlin-Auhaltische Maschinenbau AG)

This invention relates to revolving lamps which are actually airfield reference marks which simply mark the location of an airfield but do not assist in the landing. The light source is a light bulb close to the reflective surface. The reflective surface is curved, but is concave (as in U.S. Pat. No. 5,175,645) and furthermore serves to concentrate or focus the light from the bulb into a beam band to act as an airfield marker. This is contrary to the use of a convex curve in the reflector of this invention.

An important difference between the reflectors of U.S. Pat. No. 5,175,645 (Bennett) and those of this application is that Bennett's reflector is designed to be a precision approach path indicator which attempts to keep the aircraft on the correct approach slope prior to landing. The reflectors of the Applicant's invention are flare path indicators and are designed to reflect as much light as possible to demarcate a runway.

Bennett acknowledges that his reflector cannot act as a flare path indictor (column 3 lines 40-45). Unfortunately, independent testing by Civil Aviation experts has also established that Bennett's reflectors give very poor results as flare path indicators, as well as their claimed use as descent path indicators.

The main reason for the substantially different performances of the reflector of this application and that of Bennett's as a flare path indicator, is the use of an arcuate reflective surface to maximize lights reflected in order to provide the brightest possible runway demarcation from the greatest possible distance. The use of a carefully calculated compound curve maximises retro-reflectivity for the typical range of approach angles adopted by aircraft, also taking into account the fact that aircraft landing lights are not parallel with the aircraft approach angle and nor does the approach angle coincide with the pilot's observation angle (the angle between the light source and the observer pilot). The consideration of these factors is all the more important because of the limitations of the retro-reflective material used. These limitations also need to be taken into account in the establishment of the correct compound curve. Other limitations such as interference from local phenomena such as street lighting in the vicinity of the airfield atmospheric conditions (dust or moisture) and the intensity of the light source (aircraft landing lights) must also be considered.

Retro-reflective film directs most of the incident light towards the source when the reflector is perpendicular to the light source. With roadway signage, the light source (the vehicle head light) is relatively close to the driver's eye where the vehicle location is restricted to a specific lane of a road. The most effective retro-reflective material used is prismatic cubic corner type which gives a very high performance retro reflective return beam back to the light source. The retro reflector film reflectivity reduces by 50% when the observation angle, the angle formed between the observer and the light source reflected off the reflector is 0,2°, when an entrance angle to the reflector marker from the light source to the reflective has an angle of incidence of 5° when measured from a line perpendicular to the retro reflective film surface (Mr. Eduard Alf, (http://aviationmanual.homestead.com/cover.html, FIG. 8).

This is of a particular significance when the light source shines at an angle greater than 90° to the reflector and at an angle downwards greater than the 90° to the approach slope when the reflector is set perpendicular to the 3° approach slope.

Turning onto final approach, the pilot will apply 20° or 30° flaps depending on aircraft type, which results in a 8° to 12° degree pitch down of the aircraft nose and therefore an equivalent entrance angle. This will reduce reflectivity substantially greater than 50%, as light reflected down and away from the observer. Using 3M VIP Reflective Sheeting a minimum coefficient of retro reflection (Series 3990) a further 16% reduction in reflectivity for an additional 60 entrance angle is calculated giving a total reduction of 66% of the light returned to the aircraft. The standard 4509 reference aircraft landing light has a 3° main beam spread vertically and 8° horizontal spread to the half intensity points (Mr Eduard Alf, home page point 6.1, FIG. 9). Therefore a 2 mile final (12160 ft) at a 3° approach slope with 20° flaps and a nose pitch down of 9,6, the main beam focus falls short of the threshold, by 6569 ft by calculation.

The (Bennett) reflector at distance therefore relies on the peripheral beam lighting for illumination. On a flat faced reflector set at 3° as calculated previously, this peripheral light reflection is reduced by a further 66% to the characteristics of the retro reflective film and entrance angle. The flat reflector could therefore be invisible to the pilot. With the curved reflector of the invention, light enters some part of the reflector perpendicular to the surface. In this way, return light suffers no reduction in intensity, which gives substantial better results than its competitors.

The invention of Bennett Incorporated of the USA has the reflector face turned inwards between 2° and 6° to the runway centre and is a further design flaw, as the focal length of the reflector for maximum reflection focal length is drawn closer to the runway threshold before becoming visible. On an 18 m wide Code 1 runway, a reflector turned in 6° will have its focal point 85 m from the threshold.

Similarly, the patent lodged by Westly E Schieferstein with vertically placed reflectors have higher divergent entrance angles and therefore not visible at long distances. Placing reflectors in a U configuration increases the problem of a shorter focal length and can result in the aircraft approaching to land outside the 30° safety zone.

It is therefor clear from the prior art patents that the simple introduction of curvature to the reflecting surface is not sufficient to provide an effective flair path indicator. Firstly, the curvature must be convex relative to the light source, and secondly it must be carefully calculated to ensure maximum retro-reflectivity for a useful range of aircraft approach angles, by measuring various pitching angles of approaching aircraft.

The applicant's invention forces the aircraft to approach within the safe 30° cone approach and tests undertaken with the curvature taking account glide slopes and angle of lighting illuminate the flare path up to 3,1 km.

This invention does not take into account the angle of landing lights which are below the glide slope due to the nose down attitude caused by the flaps. With a curved reflector the landing light system illuminates the whole runway up to 3,1 km away from the threshold.

### DISCLOSURE OF THE INVENTION

According to the invention, a reflector device includes an arcuate surface having one or more light reflective zones and being mountable on a support element, the curvature of the arcuate surface being a compound curve permitting visibility of light reflected therefrom, from a range of angles of inclination to the vertical.

In the preferred form of the invention, the angles of inclination may range from 0° to 25° to the vertical to permit visibility of the reflected light from an aircraft approaching at a glide angle of up to 15°. In the preferred form the angles range from 60 to 25°. The angle is preferably almost vertical (6°) at the bottom of the reflector with the angle increasing towards the top of the reflector.

Also in the preferred form of the invention, the arcuate surface is mounted on a vertical pole having a series of spacers mounted thereon between the arcuate surface and the pole, the spacers increasing in width from the top to the bottom of the pole in order to achieve the compound curve.

In an alternative form, the pole may be bent or formed into the required compound curve.

In the above preferred form, a second arcuate surface may be provided which is oppositely disposed to the first to permit use of the reflector for approaches from two directions.

The support element or pole may further comprise a frangible material, or more preferably, includes a line of weakness substantially at ground level, to ensure that if the reflector of the invention is struck by a wheel of the landing aircraft, it immediately breaks off at ground level, minimising the chances of damage to the aircraft.

The support element is further provided with means for engaging a submerged pole or the like which has been augered into the ground to anchor the reflector. In the preferred form, a clip member is provided which once it has engaged the submerged pole, cannot simply be removed.

The clip is manufactured using a minimum 25 millimetres wide by 1.6 millimetre thick galvanised mild steel or corrosion resistance material. The clip is in the form of a V-section with the open leg of the V-section pointing upwards.

The one leg of the V-section is nailed to the pole 16 and is a minimum of 60 millimetres long. The other leg of the V is a minimum of 100 millimetres long and points up and outwards. 2 pairs of clips are fixed to the pole at 90° to one another. With the V pointing upwards, the pole can be easily slid into the hole (not shown), but the V will lock against the surface of the augered hole all sides of the backfilled excavation if removal or twisting is attempted.

The arcuate surface may comprise any of a number of materials including flat metal, treated timber, plastic sheeting or glass fibre sheeting, provided that it is rigidly deformable. The reflective zone or zones comprise reflector foil of various grades ranging from diamond grade, high intensity or standard engineer grade foil, depending on the position along the runway of a reflector.

It is possible to use different combinations of colours of reflective foil, but it has been established that these colours are not discernable from the air and accordingly it is proposed to use only plain white reflective foil which appears to offer best visibility.

According to aviation regulations, the maximum vertical height of this runway lighting marker above ground level shall be 700 mm for a non instrument Code No. 1 runway.

For runways narrower than 18 m, and not less 9 m, the minimum width of runway markers shall be 18 m. The area between the runway each the reflectors to be smooth and clear of obstructions. These reflectors shall not be used for runways narrower than 9 m wide.

For runways wider than 18 m, all reflectors shall be positioned 1 m wider and parallel to the finished surface of the runway.

Reflectors that are to be used as a back up for existing runway lights shall be placed outside of the line of runway lights, so as not to cause interference with visibility of the runway lights. These reflectors must be positioned so as not to interfere with the electric cables supplying power to the electric lighting system.

The runway markers shall vary in size from 600×600 mm square or 450 mm wide×600 mm high placed above runway ground level at the threshold and at 25 m centres for the first 100 m length of runway using diamond grade reflector foil or equivalent. The subsequent pairs of reflectors shall be white VIP diamond grade or equivalent 150, 300 or 450 mm wide×600 high at 50 m centres.

From midway down the runway, the reflectors may be made from either standard engineering reflector tape or equivalent, or form high intensity foil dependent of the expected local visibility conditions for the area.

The delineating markers from ½ way down the runway to the end of the runway preferably comprise VIP diamond grade will have a maximum compound back slope angle of 25°. This can be varied according to local conditions. On centre line of the runway, 25 m behind the runway end, in the direction of the take off, or as practically positioned as possible, a 600×600 diamond grade reflector marker or equivalent may be set up on the extended runway centre line for additional directional control on take off or landing.

In use, 2 motor vehicles may be positioned with their headlights shining down and parallel to the runway, illuminating the first 3 markers in their headlamp beams. The vehicles must be positioned a minimum of 15 m either side of the runway centre line and at least 25 m minimum behind the threshold.

Vehicle tail lights must remain on during landing. Hazard lights may be switched on to assist the pilot identify the airfield. The aircraft shall follow the standard approach procedures for landings on unmanned runways if radio contact is not possible with a ground radio.

Alternatively, green threshold and red runway end low energy electrical lights may be used to demarcate the threshold and runway end. Respectively in addition these lights may be used to demarcate the width of the runway, For example for an 18 m wide runaway, 6 No. 15 watt green low energy 220 volt electrical lights are positioned at 3,6 m centres to demarcate an 18 m wide runway. 6 No. 15 watt red low energy 200 volt electric lights are positioned at 3, 6 m centres to demarcate the 18 m width of the runway. These lights are energised through electric inverters plugged into the cigarette lighter holders of motor vehicles or connected directly to the vehicles battery, positioned 30 m from centre line of the runway on the left hand side of the runway when viewed from the direction of landing. The positioned red and green lights are selected so that the landing aircraft lands into the direction from where the wind is blowing (head wind).

For take off, the aircraft must taxi onto the centre line of the runway and position itself on runway heading and lining up with a centre line extended marker before attempting a take off.

The direction of the landing aircraft and positioning of the threshold lights is determined by observing the direction of the rear end of the wind sock supplied with the invention, which points at the threshold to be used.

The reflectors and lights are preferably provided in a kit form comprising threshold reflectors, reflectors and portable green and red lights arranged spaced apart on the required length of cabling. A wind sock may also be provided. The green threshold and red runway end lights provided with this invention are portable so that they can be removed and stored securely after use.

### BRIEF DESCRIPTION OF THE DRAWINGS

Embodiments of the invention are described below with reference to the accompanying drawings in which:

FIG. 1 is a front view of a reflector of the invention;

FIG. 2 is a front view of a centre-line marker reflector;

FIG. 3 is a side view of the curvature of the arcuate surface to a tilt of 25°;

FIG. 4 is a side view of the curvature of the arcuate surface to a tilt of 20°;

FIG. 5 is a side view of a double-sided reflector for bi-directional use in landings;

FIG. 6a,b,c illustrate the twist-lock clips;

FIG. 7 is a plan view of a proposed runway layout using the reflectors of FIGS. 1, 2 and 5; and

FIG. 8 is a graphical representation of curves of the coefficient of retroreflection R′ as a function of the observation angle ∝; and

FIG. 9 is a retroreflector according to the prior art.

### BEST MODE FOR CARRYING OUT THE INVENTION

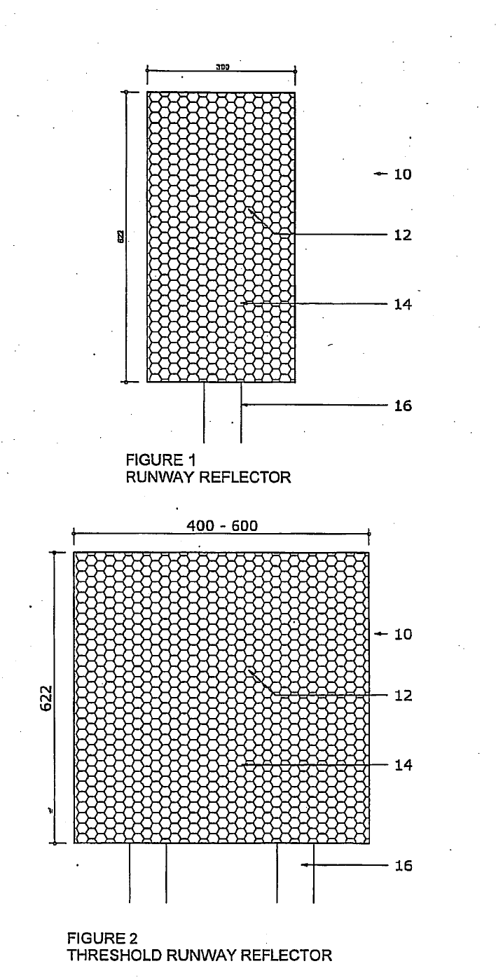

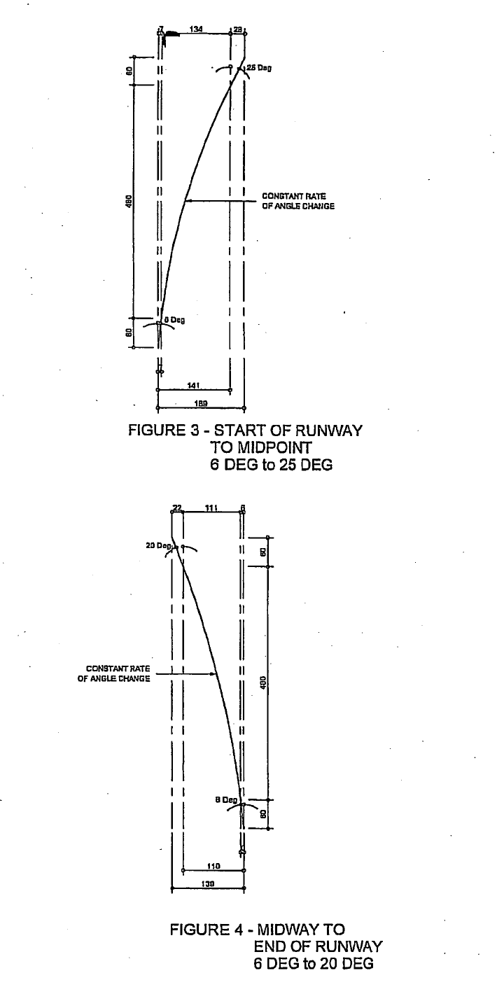

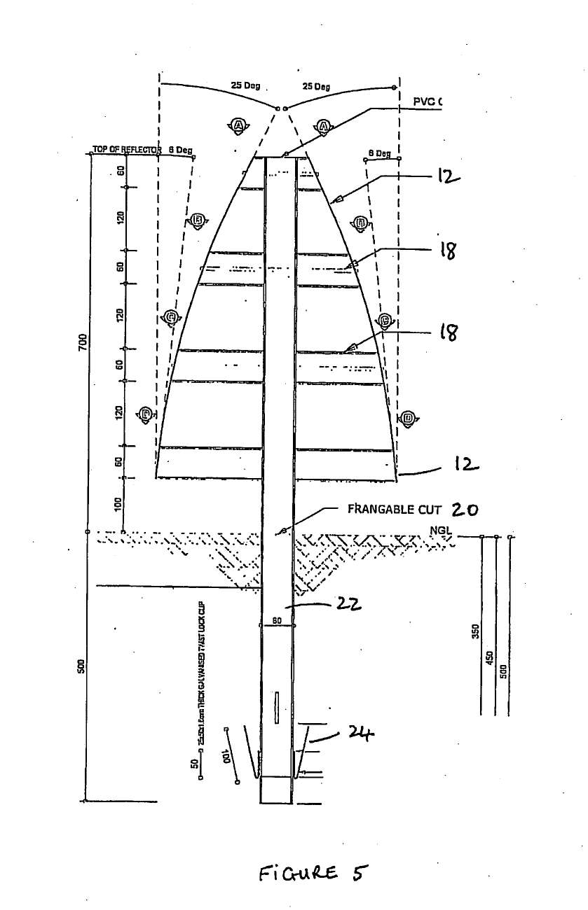

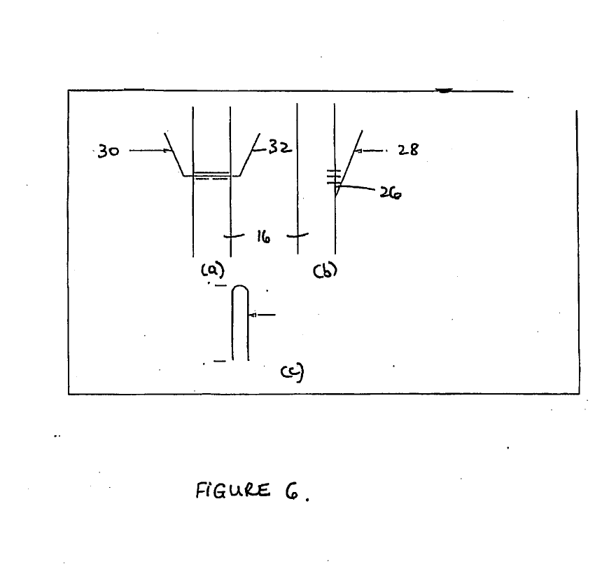

In FIGS. 1 to 5, a reflector or runway marker 10, includes an arcuate surface 12 having reflective foil 14 applied thereto. The arcuate surface is mounted on a pole or poles 16 with spacers 18 (FIG. 5) between the pole and the rear of the arcuate surface. The spacers decrease in width progressively, the higher they are located up the pole (FIG. 5) enabling the arcuate surface to be formed into a complex curve. As a result, the arcuate surface as zones of inclination to the vertical ranging from 6° to 25° (FIG. 3) or 6° to 20° (FIGS. 4 and 5).

The result is that an aircraft approaching an airfield demarcated with these reflectors, will have visibility of reflected light provided that it approaches with a glide angle of less than 15°.

The use of diamond grade reflective foil for at least the nearest reflectors to the landing end of the runway, ensures good visibility of the runway to the pilot from a significant distance away.

The reflectors of the invention include a frangible ring 20 towards the bottom end of the reflector, and in the region of the ground level. This ensures that if the reflector is struck by the aircraft during take off or landing, it immediately breaks off, minimising the possibility of damage to the aircraft.

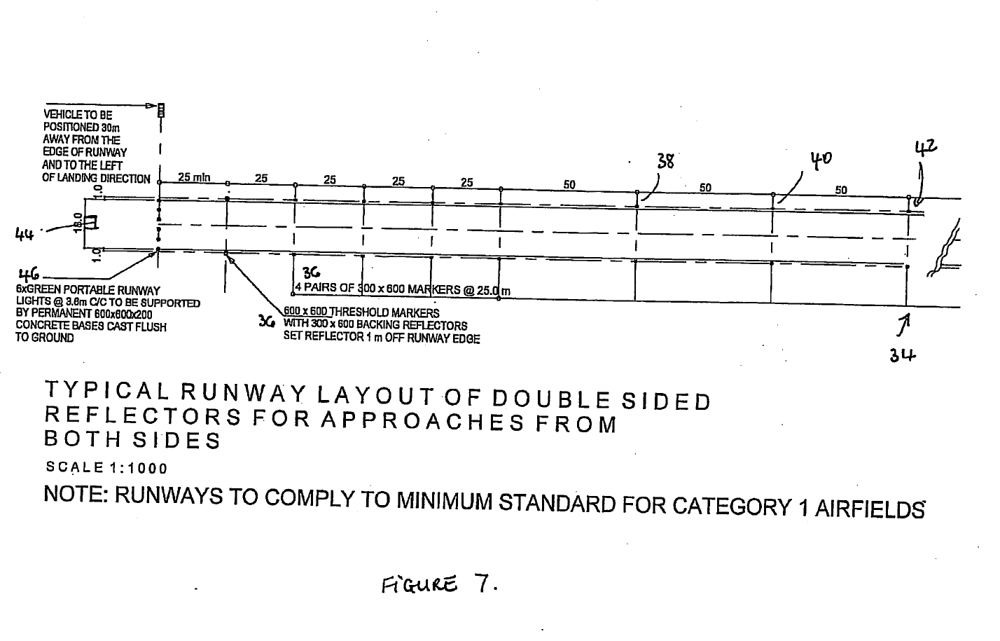

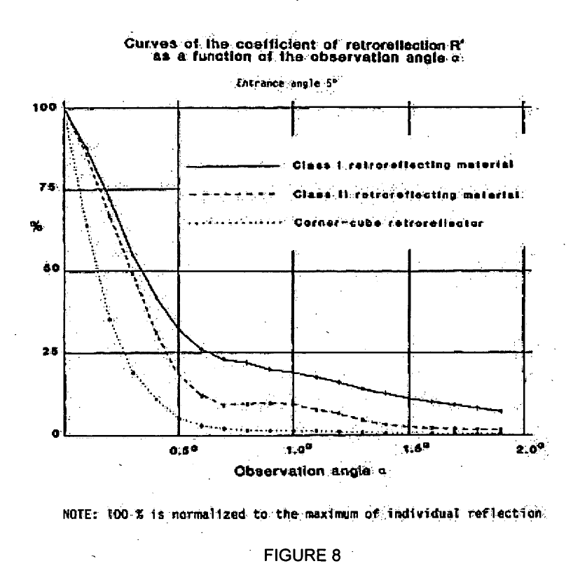

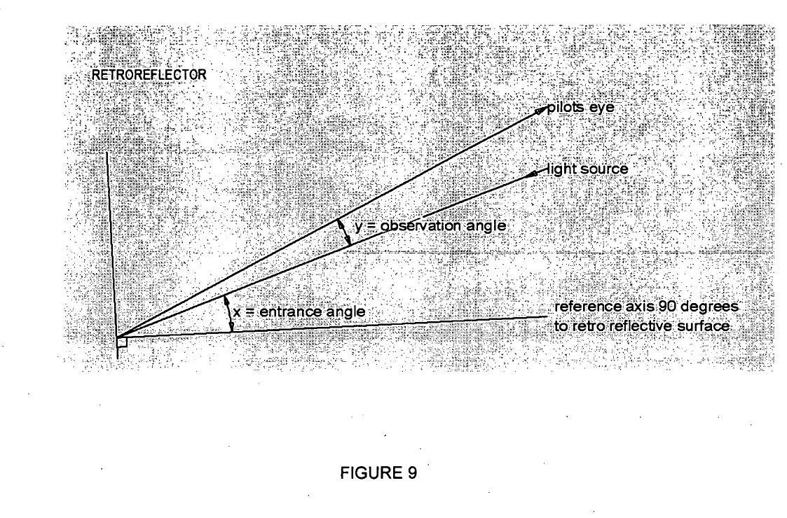

The reflectors are mounted on an anchor pole 22 and are attachable thereto by means of a twist-lock clip 24 which is shown in more detail in FIG. 6.

In FIGS. 6a-c, a twist-lock clip comprises a V-section with one leg 26 fixed to the pole and other leg 28 pointing upwards and outwards. Two pairs of clips 30,32 are fixed to the pole at 90° to one another. With the V pointing upwards, the pole can be easily slid into the hole, but the V will lock against the surface of the augered hole all sides of the backfilled excavation if removal or twisting is attempted.

Turning now to FIG. 7, a proposed runway layout is shown using reflectors of the invention. For an approach to land or take off in the direction of the arrows, the explanatory text for a left-to-right approach or take off is shown below the runway. While for an approach or take off from right-to-left, the explanatory text is shown above the runway. Each half of the runway is a mirror image of the other, about midpoint (34).

For the first 100 m, the reflectors are preferably spaced at 25 m intervals and these reflectors 36 have diamond grade reflective foil and are arcuate to an angle of 25° to the vertical. The next sets of reflectors 38 being smaller in size and having lower reflective power. Hi-intensity grade foil may be used. A further pair of reflectors 40 is located between the hi-intensity reflectors and the reflectors 42 defining the midpoint of the runway 34. Up to the midpoint of the runway, the angle of inclination to the vertical is tilted to 25°. For the midpoint reflectors and the pairs either side, standard intensity reflective foil is sufficient. After the midpoint of the runway, the angle of tilt may be lowered to 20°. The same number of reflectors demarcates the second half of the runway, with the same spacings, but from the midpoint, standard intensity reflective foil is used. Green portable lights 46 are spaced across the threshold of the runway to demarcate runway width.

Similarly red runway end lights (not shown) are placed at the end of the runway.

At either end of the runway, a diamond grade centre-line reflector 44 is located to provide directional assistance for landing and take off.

In testing, the best results were obtained using diamond grade reflector roil throughout, where the reflectors on the approach path were found to be visible from 3, 1 km using the Red Cross Air Mercy Service aeroplane. A light two-seater trainer illuminated the reflectors at 900 meters. The portable runway lights are easily seen from five kilometres.

These results were obtained inspite of the intense light pollution from the freeway lighting and street lighting adjacent the Virginia Airport, Durban where the rest were conducted.

1. A reflector device characterised in that it includes an arcuate surface having one or more light reflective zones and being mountable on a support element, the curvature of the arcuate surface being a compound curve permitting visibility of light reflected therefrom, from a range of angles of inclination to the vertical, the arcuate surface being convex relative to the light source.

2. A reflector device according to claim 1 characterised in that the reflector comprises aircraft runway markers.

3. A reflector device according to claim 1 characterised in that the angles of inclination range from 0° to 25° to the vertical to permit visibility of the reflected light form an aircraft approaching at a glide angle of up to 15°.

4. A reflector device according to claim 1 characterised in that the angles of inclination range from 6° to 25° to the vertical.

5. A reflector device according to claim 1 characterised in that the angle is 6 degrees at the bottom of the reflector, increasing towards the top of the reflector, depending on the location of the reflector on the runway.

6. A reflector device according to claim 1 characterised in that the arcuate surface is mounted on a vertical pole having a series of spacers mounted thereon between the arcuate surface and the pole, the spacers increasing in width from the top to the bottom of the pole in order to achieve the compound curve.

7. A reflector device according to claim 6 characterised in that the pole is bent or formed into the required compound curve.

8. A reflector device according to claim 1 characterised in that a second arcuate surface is provided which is oppositely disposed to the first to permit use of the reflector for approaches from two directions without re-orientation thereof.

9. A reflector device according to claim 1 characterised in that the support element comprises a frangible material.

10. A reflector device according to claim 1 characterised in that the support element includes a line of weakness substantially at ground level to ensure breakage at ground level in the event of impact with the wheel of an aircraft.

11. A reflector device according to claim 1 characterised in that the support element is provided with means for engaging a submerged pole or the like which has been augered into the ground to anchor the reflector.

12. A reflector device according to claim 11 characterised in that the engaging means comprises a clip member which resists removal.

13. A reflector device according to claim 12 characterised in that the clip member comprises a V-section with the open leg of the V-section pointing upwards, one leg of the V being secured to the support member and the other or free leg pointing upwards and outwards.

14. A reflector device according to claim 12 characterised in that two pairs of clips are affixed to the pole at 90° to one another.

15. A reflector device according to claim 1 characterised in that the arcuate surface comprises a rigidly deformable material.

16. A reflector device according to claim 15 characterised in that the material comprises one or more of flat metal, treated timber, plastic sheeting or glass fibre sheeting, singly or in combination.

17. A reflector device according to claim 1 characterised In that the reflective zone or zones comprise reflector foil of various grades ranging from diamond grade, high intensity or standard engineer grade foil, singly or in combination depending on the position along the runway of a reflector.

18. A reflector device according to claim 15 characterised in that the reflective foil comprises diamond grade foil.

19. A reflector device according to claim 17 characterised in that the foil comprises plain white reflective foil.

20. A reflector device according to claim 1 characterised in the reflectors are dimensioned to be 600 mm high, and 150 mm to 600 mm wide, the dimensions being dependent upon proposed location on a runway.

21. A reflector device according to claim 1 characterised in that the source of the light to be reflected comprises the landing lights of an approaching aircraft and/or the lights of a motor vehicle parked near the runway for this purpose.

22. A runway for aircraft using reflectors according to claim 1 characterised in that pairs of reflectors dimensioned 450 or 600 mm by 600 mm are located at the threshold of the runway and either side of the runway at 25 metre centres for the first 100 metres length of runway with subsequent pairs being located at 50 metre centres and being dimensioned at 150 mm, or 300 mm or 450 mm wide by 600 mm high.

23. A runway according to claim 22 characterised in that the reflectors after the first 100 metres may comprise a lesser grade of reflective foil.

24. A runway according to claim 22 characterised in that the threshold of the runway is demarcated with low energy green electrical lights with the runway end being demarcated with red low energy electrical lights.

25. A runway emergency landing kit comprising threshold reflectors, reflectors and portable green and red lights arranged spaced apart on the required length of cabling, and a wind sock.
